(19) United States
(12) Patent Application Publication
(10) Pub. No.: US 2026/0200364 A1
(43) Pub. Date: Jul. 16, 2026

(54) DUAL MODE ARCHITECTURE FOR ELECTRIC VEHICLE SERVICE EQUIPMENT (EVSE)

(71) Applicant: EVgo Services LLC, Los Angeles, CA (US)

(72) Inventors: Gerald Steven McAlwee, Dana Point, CA (US); Bryce Wynter, Los Angeles, CA (US); Kyle R. Underhill, Los Angeles, CA (US)

(21) Appl. No.: 19/449,160

(22) Filed: Jan. 14, 2026

Related U.S. Application Data
(60) Provisional application No. 63/745,242, filed on Jan. 14, 2025.

(51) Int. Cl. B60L 53/67; B60L 53/31; B60L 53/62

(52) U.S. Cl. CPC B60L 53/67; B60L 53/31; B60L 53/62

(57) ABSTRACT

The systems and methods described herein may implement and/or provide a flexible configuration for a charging system of electric vehicle service equipment (EVSE), such as a dual mode or multi-mode architecture or contactor matrix. The flexible configuration may include a number of switch groups (e.g., groups of power blocks that may switch between different stalls) that matches a number of output groups for each stall at a location. The switch groups may enable the flexible use and/or allotment of power blocks (via output groups and switch groups) to a stall during a charging event.

### CROSS REFERENCE TO RELATED APPLICATIONS

This application claims priority to U.S. Provisional Patent Application No. 63/745,242, filed on Jan. 14, 2025, entitled DUAL MODE ARCHITECTURE FOR ELECTRIC VEHICLE SERVICE EQUIPMENT (EVSE), which is hereby incorporated by reference in its entirety.

### BACKGROUND

Electic vehicle service equipment (EVSE) includes charging stations and associated components, such as electric conductors and computing systems that manage the efficient and safe delivery of energy to electric vehicles (EVs) to charge the batteries of the EVs. For example, EVSE may include software/firmware systems that control and manage the charging of the EVs (e.g., implementing various charging and/or communication protocols), an enclosure (e.g., often a power cabinet and separate charger) and a plug or dispender that is adapted to couple with the EVs to charge the EVs (e.g., via onboard charging systems of the EVs or directly to the batteries of the EVs).

### BRIEF DESCRIPTION OF THE DRAWINGS

Embodiments of the present technology will be described and explained through the use of the accompanying drawings.

FIG. 1 is a diagram illustrating an EVSE assembly.

FIG. 2 is a block diagram illustrating a suitable computing environment for a charging system of an EVSE.

FIG. 3 is a diagram illustrating a dual mode architecture for an EVSE.

FIG. 4 is a flow diagram illustrating an example method of providing charge to a charger of a charging station.

FIG. 5 is a flow diagram illustrating an example method of charging an electric vehicle.

FIG. 6 is a block diagram illustrating a dual mode architecture for multiple power cabinets.

FIG. 7 is a block diagram illustrating a switch system block for a dual mode architecture of an EVSE.

FIGS. 8A-8D are block diagrams illustrating implementations of a dual mode architecture for an EVSE.

FIGS. 9A-9D are diagrams illustrating example matrix operations performed by a dual mode architecture for an EVSE.

In the drawings, some components are not drawn to scale, and some components can be combined for some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

A dual mode, or multi-mode, architecture for an EVSE is described. In some embodiments, the dual mode architecture may be implemented as a charging system that controls or manages the provision of power blocks or power modules during the charging (e.g., delivery of charge or energy) to one or more EVs at a location or site. For example, the charging system may control or manage the delivery of charge/energy at a site that has multiple stalls (e.g., four to eight stalls) for charging vehicles.

Each stall may be associated with a set or defined number of power blocks or power modules, via output groups that incorporate the power modules and are assigned to the stalls. For example, a stall, which includes contactors (or switches or relays) and a plug, may be associated with an output group that contains two power blocks, each providing 50 kWs of energy during the charging of an EV at the stall (e.g., via the contactor and a plug coupled to the EV).

Such a configuration may cause certain issues when charging EVs, such as during peak or demand times (e.g., evenings), when all the stalls of a site are full of EVs charging (or requesting to charge) their batteries. For example, an EV may be at a stall that cannot meet the energy requirements to sufficiently charge the EV within a certain time period or duration and/or one or more of the power blocks of a site may be “islanded” during a charging event (e.g., when a power block is not in use during charging event and also unusable during the charging event due to limitations of the configuration).

The systems and methods described herein may implement and/or provide a flexible configuration for a charging system of an EVSE, such as a dual mode or multi-mode architecture or contactor matrix. The flexible configuration may include a number of switch groups (e.g., groups of power blocks that may switch or be flexibly allocated between different stalls), such as a number of switch groups matching a number of output groups for each stall at a location. The switch groups, which may be part of a dual mode contactor matrix, may enable the flexible use and/or allotment of power blocks (via output groups and switch groups) to a stall during a charging event.

For example, the charging system may facilitate the distribution of energy to a stall from an output group associated with the stall and a switch group that is flexibly and/or dynamically allocated or assigned to the stall. The output group may be a dedicated source of energy for the stall (e.g., providing a baseline of 100 kWs of available energy for the stall at all times), while the switch group may be associated with multiple (e. g, two, three, all) stalls at the site and be flexibly assigned to a specific stall during charging events at the site. The charging system, therefore, coordinates the provision of power blocks to various stalls during running or ongoing charging events at different stalls of a site.

In doing so, the charging system, via the dual mode or multi-mode architecture, may flexibly assign or allocate the power blocks or modules (e.g., fixed amounts of energy, such as 25 kW or 50 kW modules) to various different stalls at an EVSE site. Thus, the charging system, as described herein, may prevent the islanding of power modules at the EVSE and/or optimize the provision of energy at a site during high demand charging times or charging events, among other benefits.

### Examples of a Suitable Computing Environment

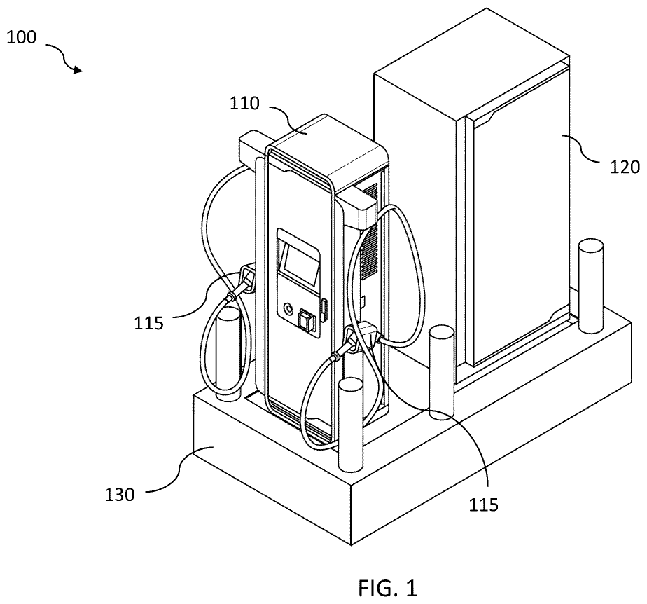

FIG. 1 is a diagram illustrating an EVSE assembly 100. The EVSE assembly 100 includes a charger 110, with associated plugs 115, and a power cabinet 120 mounted to a pad 130. The power cabinet 120 may include various components that facilitate the distribution of power or energy to an EV coupled to the charger 110 (e.g., via a plug). In some cases, the EVSE assembly 100 may be associated with every two stalls at a site or location. In other cases, the power cabinet 120 may be configured to provide power to multiple chargers 110, such as multiple chargers 110 that facilitate the charging of EVs at six or more stalls at the site or location. As described herein, the EVSE assembly 100 may include components referred to as chargers, dispensers, piles, posts, and so on.

The power cabinet 120 may include, contain, and/or store the power blocks (or power modules) that provide the power to the EVs. For example, the power cabinet 120 may include 14 to 30 power blocks that each provide 25 kW of energy to different charging events. Thus, the power cabinet 120, having 28 power blocks, can provide up to 700 kW of energy at a site, whereas the power cabinet 120 having 30 power blocks can provide up to 750 kW of energy at the site (e.g., across six to eight stalls or running charging events). Of course, power blocks, or power modules, may be of different discrete units of power, including 25 kW, 50 kW, and other amounts.

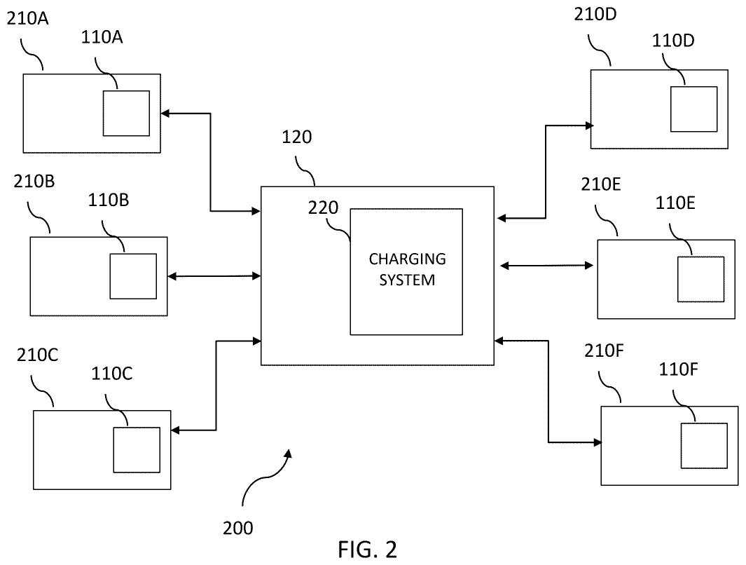

FIG. 2 is a block diagram illustrating a suitable computing environment 200 for a charging system 220 of an EVSE. As described herein, the charging system 220 may be part of the power cabinet 120 and implemented as a combination of power electronics, software, and/or firmware. The charging system 220 may communicate with multiple chargers 110A-110F at a site, such as the multiple chargers 110A-110F deployed at different stalls 210A-210F of the site. In some cases, a charger may be referred to as a dispenser, pile, and/or post. In some cases, the charging system 220 may be contained with a computing device that is in network communication with one or more power cabinets 120, such as a device or system located at a server remote from a site or station that is configured to manage operations at multiple charging stations or sites.

For example, the charging system 220 may receive or access information associated with EVs requesting to be charged, registered for charging, and/or charging at the stalls 210A-F. The information may include the type of EV, the type of battery of the EV, the state of charge of the battery of the EV, the charging protocol associated with the EV, a charging duration requested by the EV, current parameters or metrics associated with ongoing charging events (e.g., a part or session within a charging event), and so on.

The charging system 220, using the information associated with the EVs at the stalls 210A-210F, may allocate and/or assign switch groups (or individual power blocks) to the stalls 210A-210F in a dynamic and flexible manner. As described herein, each of the stalls 210A-F may be associated with a single, dedicated output group (e.g., two 25 kW power blocks) and one or more switch groups. The charging system 220, in response to ongoing charging events and charging requests, may allocate or assign the switch groups to each of the stalls on a case by case (e.g., an event by event) manner. The switch groups may include switch groups assigned to multiple (e.g., two) stalls and/or independent switch groups not assigned to any stalls. Further details regarding the dual mode architecture and the operations of the charging system 220 are described herein.

FIGS. 1, 2, and the components depicted herein, provide a general computing environment and network within which the charging system 220 can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD- ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The charging system 220 or other EVSE assemblies, components, or devices, may communicate over a network, including a wired network, a wireless local area network (LAN), a wired or wireless wide area network (WAN), the Internet, and/or another public or private network. While the connections between the various devices and the network may be shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, AR/VR devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

### Examples of the Dual Mode Architecture for an EVSE

As described herein, the charging system 220 may implement a dual mode or multi-mode switching architecture, providing a layered and/or nested structure or configuration of power modules to charging events performed at stalls of an EVSE. The charging system 220, therefore, may employ a switching matrix that facilitates the flexible switching and/or allocation of power to different stalls/chargers/dispensers at a site, based on a variety of factors or requirements.

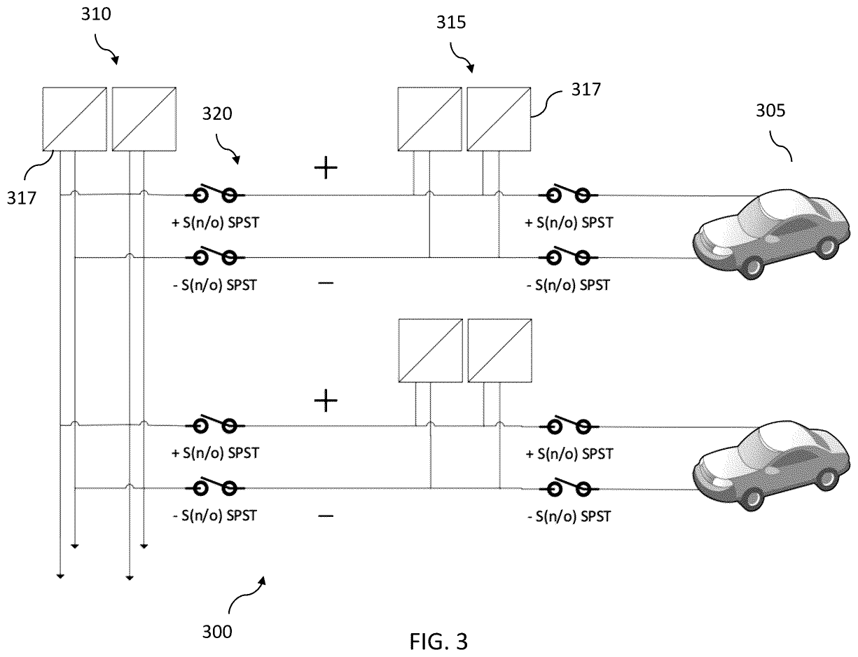

FIG. 3 is a diagram illustrating a dual mode architecture 300, or switching matrix, for an EVSE. The dual mode architecture 300 is associated with a series of stalls, where contactors 320 couple and/or connect power blocks 317, via output groups 315 (e.g., or input groups) and/or switch groups 310 to service EVs 305 at the stalls. In some cases, the contactors 320 include a single pole, single throw (SPST) contactor or a single pole, double throw (SPDT) contactor.

The switch groups 310, which contain or group power blocks 317 or power modules that provide a discrete or fixed amount of energy (e.g., 25 kW or 50 kW), are connected, in a flexible fashion, to the stalls via the contactors 320. For example, the charging system 220 may dynamically assign a switch group 310 for a charging event at one or more of the stalls (or chargers).

In some examples, an output group 315 (and/or input group, to facilitate bi-directional charging from an EV into the EVSE and/or to other EVs) is associated with or assigned to a charging stall. Via a contactor set (e.g., SPST and/or SPDT), an output group 315 may combine with one or more of the switch groups 310 to provide power through other output group contactor sets to other charging stalls.

In some cases, an output group contactor may have a current rating and cycle life capability that is the largest/highest of the architecture 300 or topology (e.g., with respect to the current rating and/or cycle life capability of contactors for the switch groups 315). Such characteristics may limit a total charging current and/or power to a connected EV, and the charging system 220 may utilize and/or incorporate an independent switch group or additional (e.g., parallel) switch matrix, as described herein.

Further, output group contactors may be capable of performing redistribution and/or reassignment operations for the charging system 220. Thus, the charging system 220 may utilize or select output group contactors to handle a higher number of cycles. Further, as described herein, the charging system 220 may employ the output groups 315 to pre-charge a charging cable (e.g., for the plug 115) upon initiation of a charging event and be connected to an EV during a vehicle battery system contactor closing event. Given likely increases in battery system pulse powers for EVs, the charging system 220, instead of the EVs, may flexibly assign output groups 315 or independent switch or output groups to pre-charging events via the architecture 300.

In some examples, the switch groups 310 may be associated with the output groups 315 via contactor sets (e.g., SPST or SPDT) that connect to the output groups 315 and their contactor sets. The switch group 310 adds current and power capacity to any charging stalls in a flexible and/or dynamic manner. In some cases, multiple contactor sets may combine multiple output groups 315 to other charging stalls via associated output group contactor sets.

Further, the rating of a switch group contactor set that connects through closed output group contactors may carry the sum of the currents of the power modules in the associated switch group as well as other connected output groups. In some cases, the value may be limited by the current capacity of the output group contactor, which may also carry the current of the output group to a connected EV.

In some cases, the output groups may act as input groups, where the output groups, operating as input groups, enable the transfer of power or charge from an EV into the power cabinet (or to other locations). Thus, the output groups may be considered input/output groups, facilitating bi-directional charging, such as vehicle to grid (v2g), vehicle to everything v2x), grid to vehicle (g2v), and so on.

In some examples, the power blocks 317 or power modules may include a Current-Mode Control (CMC) type architecture to achieve greater bandwidth for stability while adding power to an output DC-link, may match the voltage of a connected DC-link of an output channel prior to connecting to the power modules, may have one power module that supports Voltage-Mode Control (VMC) to pre-charge aggregated DC-coupled filters of all modules in a group when connecting to an output DC-link, may pre-charge an operating DC-link using power modules with a voltage compensated Pulse-Width-Modulation (PWM) capability, and so on.

In some examples, the EVSE may include multiple power cabinets, where each cabinet includes a group of power blocks or modules. The charging system 220, deployed in one of the cabinets (or as a separate component or device), may utilize power blocks, and thus switch groups, from different and/or multiple cabinets, when allocating power blocks to chargers or stalls at a site. Further, the charging system 220 may facilitate the allocation of power (via power blocks) from one power cabinet to another (e.g., via contactors contained within the power cabinets).

In some examples, the multi-mode architecture may include independent switch groups (and/or independent output groups) and/or an independent switch matrix associated with a main matrix (e.g., connected in parallel to the main matrix). Using the independent switch/output groups, the architecture may facilitate the deployment of additional switch groups to chargers and/or stalls. In some cases, the independent switch groups may act as output groups for a charger and/or stall, such as when the stall's associated output group (or contactor) is offline and/or otherwise unavailable.

The independent switch/output groups, or independent groups, connect through contactor sets (e.g., SPST or SPDT) to an outboard side of output group contactors and may act in parallel with the contactor set of the main matrix (e.g., the contactors for the switch groups 310 and/or output groups 315) supporting a site or one or more stalls. In some cases, contactor sets for the independent groups may support their current and power. The charging system 220 may flexibly deploy the independent groups to support short-term current demands (e.g., early in a charging session) and then disconnect and re-deploy the independent groups similarly to other connected EVs during high current demand portions of their charging sessions. Thus, the charging system 220 may perform life cycle management of a power cabinet, while also supporting a charging session with a certain level of current and power during failure events (e.g., output group contactors are not closing).

In some cases, such as at sites where there are a smaller number of stalls (e.g., four or fewer), a larger number of power blocks may be provided as independent switch groups to the stalls, providing additional flexibility to charging events at the stalls. Thus, the charging system 220 may create or generate a virtual stall at a site by assigning an independent switch group as a dedicated output group, pairing the switch group to a contactor.

Thus, the multi-mode (e.g., dual mode) architectures (e.g., the architecture 300) described herein may provide enhanced charging, reliability, and/or redundancy to a main charging matrix of an EVSE, among other benefits.

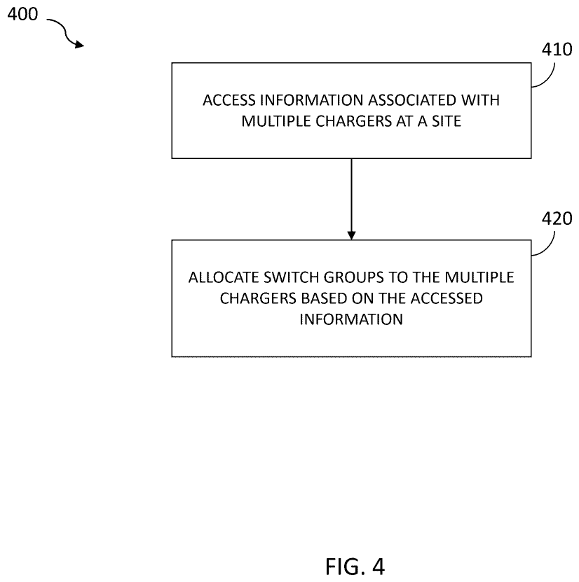

As described herein, the charging system 220 may perform various operations when providing power or charge to a stall and/or one or more chargers at a site. FIG. 4 is a flow diagram illustrating an example method 400 of providing charge to a charger of a charging station. The method 400 may be performed by the charging system 220 and accordingly, is described herein merely by way of reference thereto. It will be appreciated that the method 400 may be performed on any suitable hardware.

In operation 410, the charging system 220 may access information associated with multiple chargers disposed at multiple stalls of a site. The charging system 220 may access or receive information that identifies a load applied by an EV at one of the chargers or stalls at a site, information that identifies an overall load applied by multiple EVs charging at a site, information that identifies a predicted load to be applied to the multiple chargers or stalls at a site, information that identifies a specific part or portion of a charging session, and so on. Further details regarding the information accessed and/or utilized by the charging system 220 are described herein.

In operation 420, the charging system 220 may flexibly allocate switch groups to the multiple chargers based on the accessed information, where a switch group contains multiple power blocks that provide a discrete amount of energy to a charger during a charging event at a stall. For example, the charging system 220 may connect or couple, via contactor sets, the switch groups to output groups assigned to the multiple chargers.

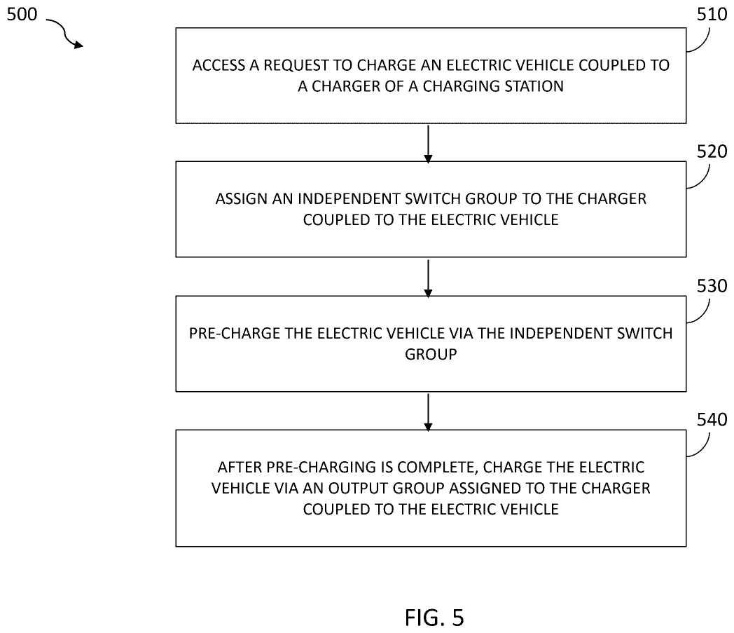

As described herein, in some examples, the charging system may utilize independent switch groups (or independent output groups) to perform pre-charging before charging a connected EV. FIG. 5 is a flow diagram illustrating an example method 500 of charging an electric vehicle. The method 500 may be performed by the charging system 220 and accordingly, is described herein merely by way of reference thereto. It will be appreciated that the method 500 may be performed on any suitable hardware.

In operation 510, the charging system 220 accesses a request to charge an EV coupled to a charger of a charging station. For example, the charging system 220 may receive an indication that an EV has plugged into the charging station 100 via the plug 115 of the charger 110.

In operation 520, the charging system 220 assigns an independent switch group to the charger coupled to the EV. For example, before connecting an output group assigned to the charger, the charging system 220 connects an independent switch group (or independent output group) to the charger for pre-charging.

In operation 530, the charging system 220 pre-charges the EV via the independent switch group. For example, the charging system 220 may utilize the independent switch group to bring up the voltage and/or perform power width modulation (PWM) to regulate the power and/or control the voltage applied to the charger before charging the connected EV.

In operation 540, the charging system 220, after the completion of pre-charging, charges the EV via an output group assigned to the charger coupled to the EV. For example, the charging system 220 may then connect the output group to the charger to begin charging the battery of the EV. Of course, the charging system 220 may utilize the various operations described herein with respect to the switch matrix and/or flexible allocation of power modules.

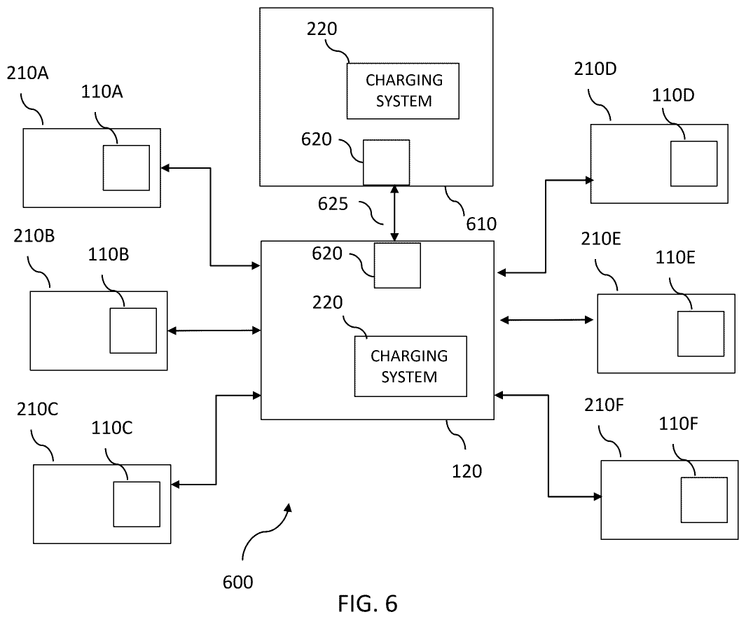

As described herein, in some examples, a power cabinet may utilize the charging system 220 to provide power to other power cabinets. FIG. 6 is a block diagram illustrating a dual mode architecture 600 for multiple power cabinets. A power cabinet 610 may be configured, via the charging system 220, to flexibly provide power to the power cabinet 120, which is associated with the stalls 210A-210F.

For example, the charging system 220 may form one or more switch groups of power blocks within the power cabinet 610, and couple, via an internal contactor 620, the power blocks to the internal topology of the power cabinet 120 (e.g., the architecture 300). Thus, the charging system 220 may form an output channel 625 between the power cabinets 120, 610, enabling one power cabinet (e.g., the power cabinet 610) to leverage additional power capacity (e.g., power blocks or power modules via switch or output groups) from another power cabinet (e.g., the power cabinet 120).

The charging system 220, therefore, may be configured to identify one or more power blocks associated with a second charging matrix, assign the one or more power blocks to a charging event associated with a first charging matrix, and cause a charger or dispenser associated with the first charging matrix to charge an EV using power form the assigned one or more power blocks. Further details are described herein.

Thus, the various topologies or configurations of switch groups, output groups, and/or independent groups provide a flexible and/or modifiable source of power capacity for a charging station or site. Using the flexibility of the topologies, the charging system 220 may support different levels of service at a site, such as lanes or stalls that are dedicated to different power levels (e.g., high and low power lanes or stalls) in a temporary or on-demand manner (e.g., during peak hours or in response to inbound charging reservations for certain EVs). Further, the topologies may facilitate the nesting of power blocks/modules, where certain modules are arranged in a hierarchy and grouped to provide power in a tapered or dynamically changing manner.

Further details regarding the dual or multi-mode architecture 300 and/or the operations of the charging system 220 will now be described. As described herein, the architecture 300 may provide a power distribution topology for EVSEs, where the charging system 220 efficiently utilizes available grid connection power for charging station sites. The topology may include a layered configuration of switch groups, which include a paired set of SPST or SPDT contactors (e.g., a contactor set) along with one or more power blocks or modules (e.g., AC/DC or DC/DC power modules). Via the topology, the charging system 220 may dynamically manage connected vehicle loads and/or achieve a higher levelized cost of energy (LCOE) for an installation, among other benefits.

In some examples, the architecture 300, or multi-mode AC/DC contactor matrix, addresses the risk of having many vehicles with near flat power vs state of charge (SoC) curves (e.g., due to an increased use of high capacity lithium ion phosphate (LFP) chemistry), populating and/or charging at a site. Thus, the architecture 300 may provide a small resolution capability, while satisfying national electric vehicle infrastructure (NEVI) standards for 6-stall or 4-stall installations. In some cases, the architecture 300 may enable a fine resolution and the ability to hit 600 A while keeping a footprint of the AC/DC as small as possible. The matrix design or configuration may offer a suitable or maximum possible flexibility. In some cases, a minimum of 28 power modules are used to facilitate compliance for NEVI sites (e.g., where the matrix may implement more switch groups than output groups).

As described herein, the architecture 300 may employ additional switch groups, such as the independent switch groups. These switch groups connect to an output side of the output groups and are thus connected in parallel to the contactors of the output groups. The use of the additional switch groups may add reliability, because channel output power may be 100% dependent on the output group contactors, and the power may come from any combination of independent switch groups.

For example, a power cabinet may provide 700 kW of power for a 6-stall site using 28 power modules. In some cases, a 4-stall design may depopulate output groups for 600 kW. As described herein, both output groups and switch groups use 50 kW power blocks, thus only one 50 kW may be “islanded” per unoccupied stall for a max island total for 5 stalls of 250 kW. Thus, even for a 700 kW power cabinet, 450 kW can be applied to one stall. In some cases, the output groups may use 500 A contactors and the switch groups may use 150 A contactors.

In some cases, the independent switch groups may connect via 150 A contactors, which can connect to any output group, but instead of connecting to the same inboard post of an output group contactor as a normal switch group, they connect on an outboard post. Hence, they can act in parallel to a previous or main matrix and facilitate a 600 A capability. The independent switch groups (ISWGRP) may be defined as follows:
ISWGRP 7-50 kW Block (This Block is 50 kW to allow NEVI Compliance even with 6-stall Cab using S/W)
ISWGRP 8-25 kW Block;
ISWGRP 9-25 kW Block;
ISWGRP 10-25 kW Block (depending on space); and
ISWGRP 11-25 kW Block (depending on space).

The architecture 300 may facilitate various operations modes or configurations. For example, an output group can connect to a stall along with any number of standard switch groups (e.g., each 50 kW) to their associated stall (e.g., a primary or flexible stall). Then, any number of independent output groups can be added, and/or any number of independent switch groups can support a stall without connecting an output group (e.g., providing an enhanced overall stall reliability by supporting a stall despite a busted output group with up to 100 kW). For example, by providing IDSWGRPs 7, 8, and 9, and, optionally, IDSWGRPs 10 and 11, the architecture 300 can realize 150 kW of provided energy.

Thus, in some examples, the independent groups described herein may be used alone or in parallel with an output group to “right size” the characteristics for a vehicle battery system that is pre-charging an output channel DC-link from a dispenser, pile, post, and/or other connection hardware, may only include capacitors with or without a link-damper architecture (e.g., a series element of an inductor with a paralleled resistor across the inductor), may have a number of contactor pairs that matches or is less than a number of output groups and connection hardware when differentiated channel management is desired, may be driven by a different controller than other power modules to achieve gains in system resilience, and so on.

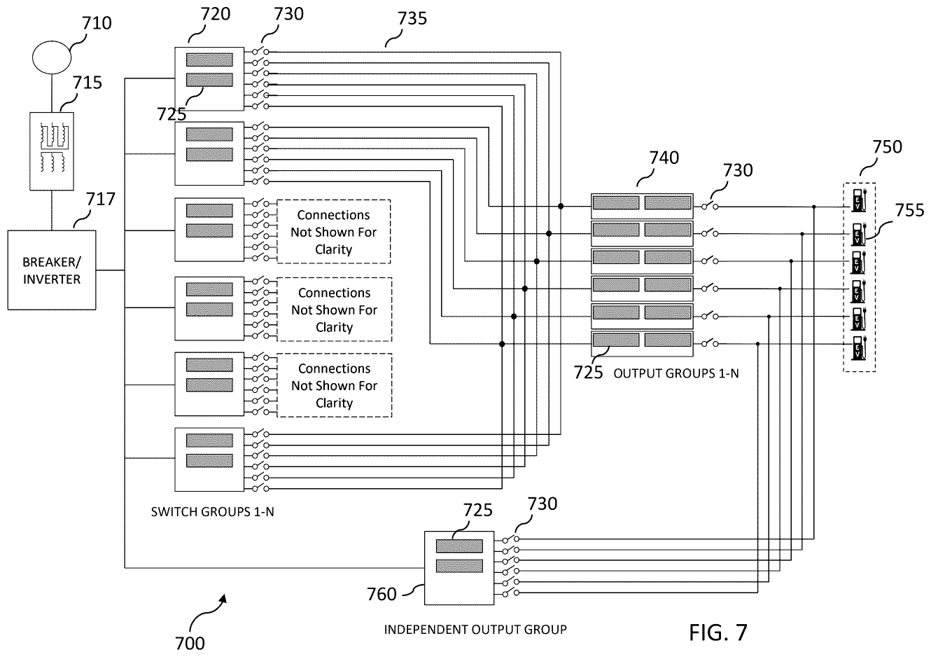

FIG. 7 depicts an example switch system block 700 for a dual mode architecture of an EVSE. A breaker/inverter 717 and associated switchboard may be positioned between a transformer 715 that is coupled to a grid point of interconnection (which connects to an electric grid, not shown). The breaker/inverter 717 may be a component that includes an AC switchboard and breaker for an AC coupled system or an AC switchboard, breaker, and AC/DC inverter for a DC coupled system. In some cases, the breaker/inverter 717 (and/or switchboard) includes a branch breaker to protect the conductors between the switchboard and the coupled switch system block 700.

In some cases, the transformer 715 may be a medium voltage (MV) to low voltage (LV) transformer. For example, the transformer 715, as a MV transformer, may directly connect (without a principal transformer) using power modules that achieve galvanic isolation using capacitive coupling and/or via distributed high frequency (HF) transformers that output either LV AC, MV DC, or LV DC. Thus, the charging system 220 may utilize a central grid tie AC/DC Inverter where the power blocks or modules are DC/DC elements, or where the power modules are each AC/DC inverters.

The switch system block 700 includes a main charging matrix of switch groups 720 (e.g., SGs 1-N), coupled to output groups 740 (OGs 1-N) via contactors 730 and conductors 735. The output groups 740 are coupled via contactors 730 to EV chargers 755 within an array of EVSE 750 (e.g., multiple chargers/dispensers/piles, posts). Further, an independent output group 760 is coupled, via the contactors 730, to the EVSE array 750. As described herein, each of the switch groups 720, the output groups 740, and/or the independent output group 760 includes or groups one or more power blocks 725 or modules, such as two power blocks 725.

In some cases, the switch system block 700 may realize various configurations, such as a configuration where N output groups 740=a number of dispensers/piles/posts in the EVSE array 750, which may be based on having the independent output (or switch) group 760.

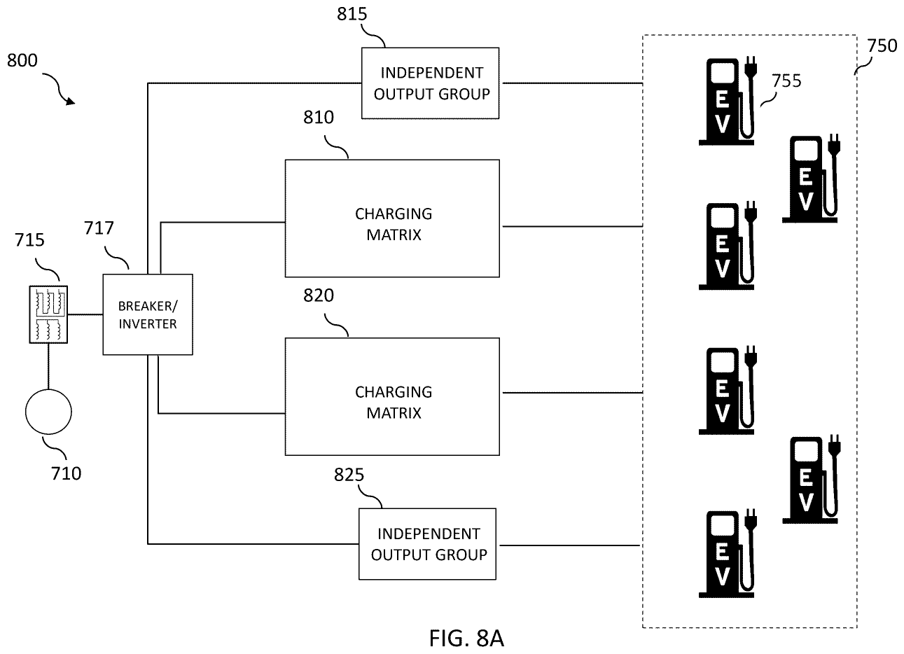

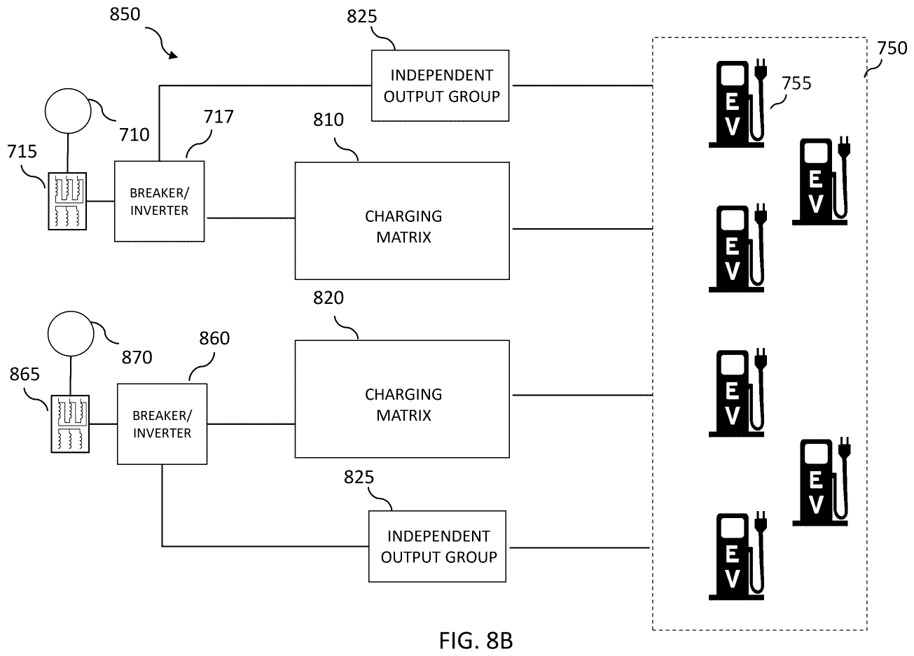

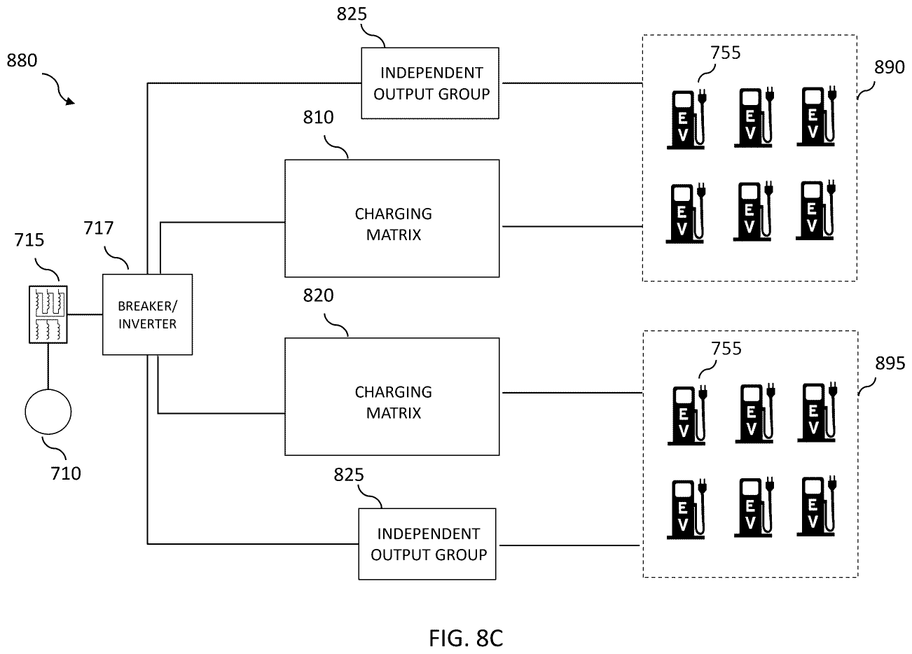

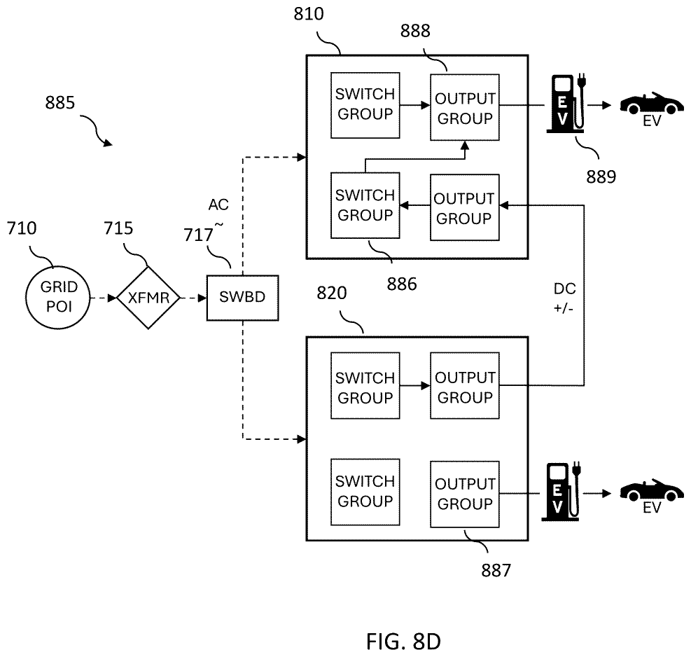

FIG. 8A depicts an example topology 800 having parallel switch system blocks or charging matrixes. As shown, a first charging matrix 810 is connected in parallel with a second charging matrix 820 to the EVSE array 830 and via one switchboard or meter connection. Further, an independent output group 815 may be associated with the first charging matrix 810 and an independent output group 825 may be associated with the second charging matrix 820. The topology 800, therefore, may have a configuration where a single switchboard supports the two charging matrixes 810, 820 (or power cabinets), and where (N×M) output groups (for the two charging matrixes 810, 820)=total dispensers/piles/posts in the EVSE array 750, depending on the independent output groups (e.g., (N×M) or less than (N×M)).

FIG. 8B depicts an example topology 850 having parallel switch system blocks or charging matrixes and multiple (M) switchboard or meter connections. As shown, the charging matrix 810 is coupled with the breaker/inverter 717 and the charging matrix 830 is coupled with a different breaker/inverter 860 (and associated transformer 865 and POI 870. The topology 850, therefore, may have a configuration where (M) switchboards support (M) or greater than (M) charging matrixes, and where (N×M) output groups (for the two charging matrixes 810, 820)=total dispensers/piles/posts in the EVSE array 750, depending on the independent output groups (e.g., (N×M) or less than (N×M)).

FIG. 8C depicts an example topology 880 with output (or input) channel power sharing. As shown, the charging matrix 810 may be coupled with a first EVSE array 890 and the charging matrix 820 may be coupled with a second EVSE array 895. The topology 880, therefore, may have a configuration where (M) switchboards support (M) or greater than (M) charging matrixes via 1 to (M) or less than M switchboard or meter connections, and where ((N−1)×M) output groups=a total number of dispensers/piles/posts in the EVSE array 890 and the EVSE array 895. Further, the topology may support power sharing though an output group (N+M) of the charging matrix 810 being connected to the output group (N+M) of the charging matrix 820 or to any other (N+M) output group. In some cases, associated switch group contactor capacities may limit the shared amount of current, and thus an increase to the capacity of specific switch group contactors may facilitate full sharing between the charging matrixes.

FIG. 8D depicts an example topology 885 supporting and/or implementing power sharing between two (or more) charging matrixes. For example, one or more output groups and/or switch groups 887 from a second charging matrix (e.g., the charging matrix 820) contribute power/energy (via pathways shown as “B”), via switch groups 886, to output groups 888 and a dispenser (and associated EV) 889 output of a first charging matrix (e.g., the charging matrix 810). Thus, as shown, the dispenser 889 on a first channel of a first charging matrix can meet a demanded load using power from two charging matrixes (e.g., via connections between switch groups, output groups, and/or associated chargers/dispensers).

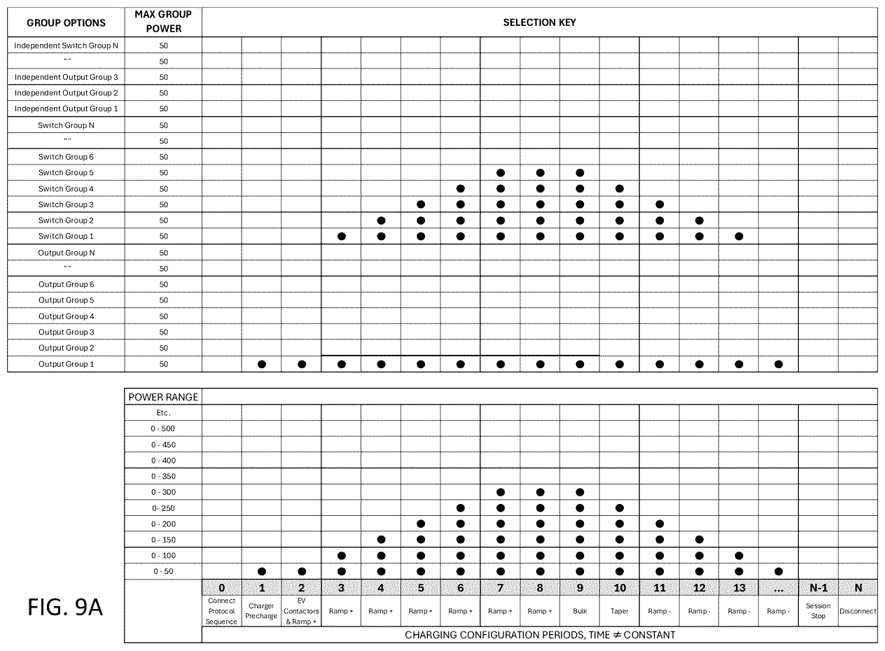

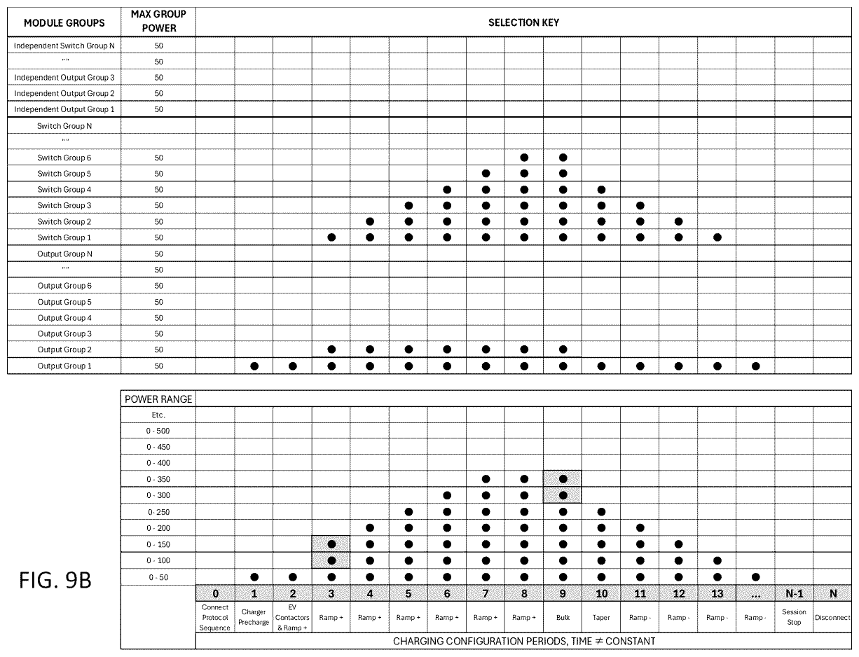

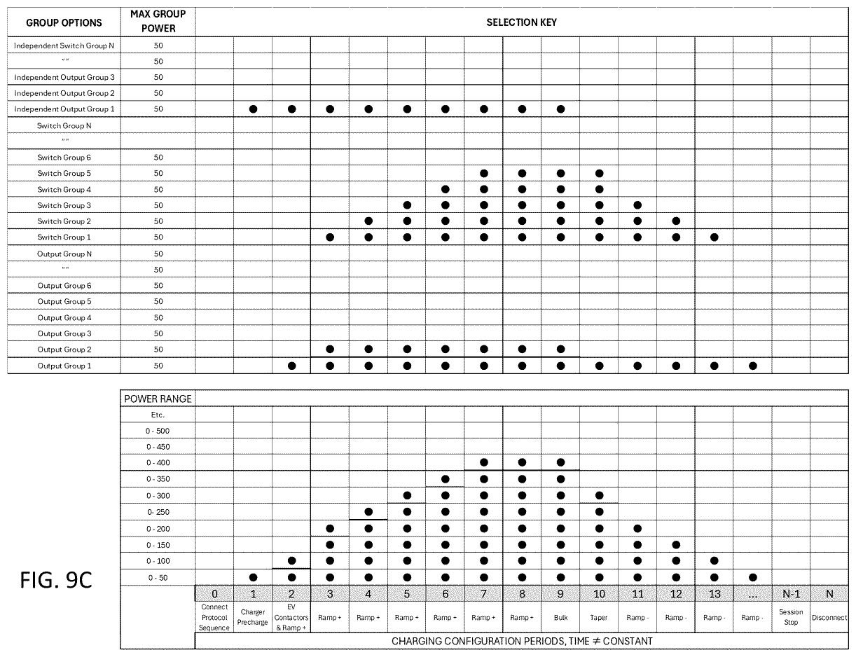

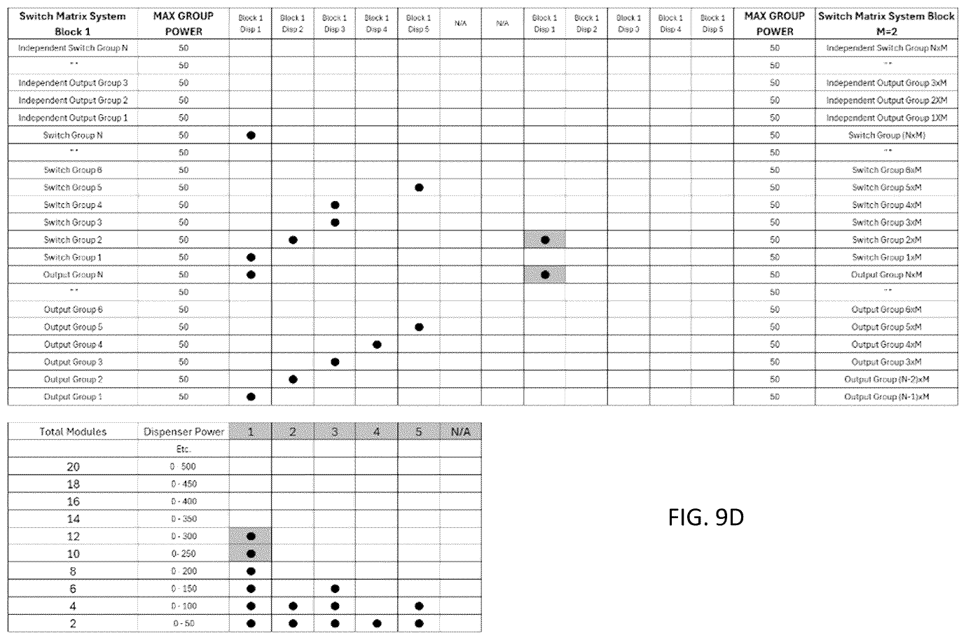

As described herein, the dual mode architecture 300, via the charging system 200, may support various charging matrix operations for a charging station or site. FIGS. 9A-9C are diagrams illustrating example matrix operations performed by a dual mode architecture for an EVSE. In some cases, any or all power modules or groups may have unique or shared current and/or power ratings, depending on the number of modules in a group.

FIG. 9A depicts a basic connection sequence using an initial module output group for pre-charging and current addition up to peak capability followed by a ramp up in current and power enabled by adding switch groups connected to an EVSE dispenser of a stall. As shown, the charging time for an EV charging past a 50% SoC is within “Taper” and Ramp Down (“Ramp”) configuration periods. The taper period ends when the charging system 220 pulls or reallocates switch groups, or other connected modul groups, of the stack and moves to a next configuration period ramp down configuration to achieve a higher efficiency. The charging system 220 may utilize various rules when allocating switch groups, such as those that prioritize efficiency over vehicle current (power) demands, or vice versa.

When charging is terminated or completed, all connected modules are turned off, the charger and vehicle contactors are opened, and the plug is disconnected from the vehicle. In some cases, at some minimum power level, the charger may be programmed to terminate the charge to allow module (e.g., switch group) assignment to other vehicles at the charging station.

FIG. 9B depicts a combination of applying another output group simultaneously when adding a switch group. The use of the output group and switch group may facilitate faster power ramping for a given vehicle current request and/or power that would not be available from other switch groups if they were assigned to other output groups at the same time. Further, assigning another output group, when available early in the charging session when the vehicle battery SoC is low, enables the output group to contribute to the current and power and then be removed before commencement of the taper part of the charging session (e.g., the part that accounts for the majority of the total time required to complete a charging session to higher SoCs). Thus, the charging system 220 may flexibly apply its power modules efficiently and with high reliability.

FIG. 9C depicts the charging system 220 flexibly allocating independent groups for pre-charging, where the independent groups and their contactors support a pre-charging event for an EV, reducing the capacitance and stress on the main matrix power modules within output and switch groups. For example, the charging system 220 may optimize and/or enhance one or more independent groups for pre-charging, such as to accommodate higher pulse power electric vehicle battery packs.

FIG. 9D depicts the charging system 220 supporting and/or implementing power sharing between two (or more) charging matrixes. For example, one or more output groups or switch groups from a second charging matrix (e.g., the charging matrix 820) contribute power/energy to the output groups and dispenser output of a first charging matrix (e.g., the charging matrix 810). Thus, as shown, a dispenser on channel 1 of block A can meet a demanded load using power from two charging matrixes. In addition to facilitating power sharing between power cabinets, such a topology may manage utility connection power limits vs charging site utilization. Of course, the charging system 220 may reduce native power per cabinet in a variety of ways, such as via fewer power modules in a switch group and/or output group, the selected depopulation of an EVSE cabinet, and so on.

Further, the use of the independent groups may add significant uptime reliability, such as when coupled with a dedicated controller different from a controller used in a main power matrix. For example, when the independent groups have a higher cycle life, the groups can be assigned early in a charging session when vehicle battery (SoC) is low, contributing to the higher current and power requirements. Once that portion of the charging session ends, the independent groups may be removed, such as before the charging session enters the taper part of the session. In some cases, independent groups may utilize additional packaging volume, although the benefit of applying power modules efficiently, with higher system reliability, which can result in a lower operational LCOE, can outweigh the additional space requirements.

In some examples, the output (or input) groups may be connected to a dispenser with or without additional power contribution from switch groups, may provide power through switch groups to other output groups and to a different dispenser, may include one power module having VMC to pre-charge the aggregated DC-coupled filters of all modules in the group when connecting to an active dispenser channel DC-link when the pre-charge of the DC-link was achieved using an independent group or through a switch group to a different combined output group and dispenser channel, may pre-charge to the operating DC-link using power modules with voltage compensated PWM capabilities, may be paralleled with other output groups with one switch group, where each output group pre-charges independently, and son on.

In some examples, the switch groups may be connected to an output group by itself or in parallel combination with switch groups, may provide power through switch groups through other output groups, and then to a different dispenser, and so on.

In some examples, a single charging matrix or main matrix may be driven off single or multiple controllers to achieve “cross strapping” for added reliability and/or to attend to communication bus bandwidth constraints, among other things.

### Example Embodiments of the Disclosed Technology

The technology may be implemented as various embodiments or examples, as described herein.

For example, a system associate with EVSE may include a processor coupled with a memory and configured to access information associated with multiple chargers disposed at multiple stalls of a site and flexibly allocate switch groups to the multiple chargers based on the accessed information wherein a switch group contains multiple power blocks that provide a discrete amount of energy to a charger during a charging event at a stall.

In some cases, each charger is associated with one or more output groups, and wherein a number of switch groups associated with each charger is equal to a number of the one or more output groups.

In some cases, each charger is associated with one or more output groups, and wherein a number of switch groups associated with each charger is greater than a number of the one or more output groups.

In some cases, the switch groups include a set of independent switch or output groups that are not associated with any stalls of the multiple stalls of the site.

In some cases, the processor is further configured to flexibly allocate an independent output group to the multiple chargers based on the accessed information.

In some cases, the information associated with the multiple chargers disposed at the multiple stalls of the site includes information that identifies a load applied by an electric vehicle at one of the chargers of the multiple chargers disposed at the multiple stalls of the site.

In some cases, the information associated with the multiple chargers disposed at the multiple stalls of the site includes information that identifies a load applied by multiple electric vehicles charging at the multiple chargers.

In some cases, the information associated with the multiple chargers disposed at the multiple stalls of the site includes information that identifies a predicted load to be applied to the multiple chargers disposed at the multiple stalls of the site.

In some cases, each switch group includes two power blocks.

In some cases, each power block provides 25 kilowatts or 50 kilowatts of power to a charger disposed at the multiple stalls of the site.

In some cases, the processor is further configured to flexibly re-allocate one or more switch groups in response to completion of a charging event at the multiple chargers.

In some embodiments, a power cabinet for an EVSE may include multiple power blocks that provide a discrete amount of energy to a charger during a charging event with an EV connected to the charger; and a charging system that dynamically allocates the multiple power blocks to two or more chargers associated with the power cabinet.

In some cases, the charging system groups the power blocks into switch groups of multiple power blocks and allocates the switch groups to the two or more chargers associated with the power cabinet during multiple charging events powered by the EVSE.

In some cases, the charging system is configured to group the power blocks into switch groups of multiple power blocks and allocate each switch group to a charger of the two or more chargers.

In some cases the charging system is configured to group a first subset of power blocks into switch groups of multiple power blocks and group a second subset of power blocks into output groups of multiple power blocks, wherein the switch groups are dynamically allocated to the two or more chargers and the output groups are assigned to the two or more chargers.

In some cases, the charging system is configured to group a third subset of power blocks into an independent output group of multiple power blocks.

In some cases, the charging system is configured to group a first subset of power blocks into a switch group associated with high power charging of EVs and group a second subset of power blocks into a switch group associated with lower power charging of EVs, wherein the first subset of power blocks has a number of power blocks that is larger than a number of power blocks of the second subset of power blocks.

In some cases, the power cabinet includes a contactor that couples the two or more chargers to the power cabinet.

In some embodiments, a multimode architecture for a power cabinet of an EVSE may include multiple output groups connected to chargers associated of the EVSE via contactors and multiple switch groups flexibly connected to the chargers of the EVSE via the contactors, wherein an output group and a switch group includes multiple power blocks that provide a discrete amount of energy to a charger during a charging event with an EV connected to the charger.

In some cases, the multi-mode architecture of claim 18 includes a charging system that dynamically allocates the multiple switch groups to the chargers of the EVSE.

In some cases, a contactor associated with a switch group is smaller in size than a contactor associated with an output group.

In some embodiments, a charging system accesses a request to charge an EV coupled to a charger of a charging station, assigns an independent switch group to the charger coupled to the EV, pre-charges the EV via the independent switch group, and, after the completion of pre-charging, charges the EV via an output group assigned to the charger coupled to the EV.

In some cases, the charging system connects the output group to the charger to begin charging the battery of the EV.

In some embodiments, the charging system identifies one or more power blocks associated with a second charging matrix, assigns the one or more power blocks to a charging event associated with a first charging matrix, and causes a charger or dispenser associated with the first charging matrix to charge an EV using power form the assigned one or more power blocks.

In some cases, the charging system allocates one or more switch groups that contain the assigned one or more power blocks of the second charging matrix to the first charging matrix.

In some cases, the charging system causes the charger to charge the EV using the allocated one or more switch groups, output groups assigned to the charger, and one or more switch groups from the first charging matrix.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the technology are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A system associated with electric vehicle service equipment (EVSE), the system comprising:
a processor coupled with memory and configured to:
access information associated with multiple chargers disposed at multiple stalls of a site; and
flexibly allocate switch groups to the multiple chargers based on the accessed information,
wherein a switch group contains multiple power blocks that provide a discrete amount of energy to a charger during a charging event at a stall.

2. The system of claim 1, wherein each charger is associated with one or more output groups, and wherein a number of switch groups associated with each charger is equal to a number of the one or more output groups.

3. The system of claim 1, wherein each charger is associated with one or more output groups, and wherein a number of switch groups associated with each charger is greater than a number of the one or more output groups.

4. The system of claim 1, wherein the processor is further configured to flexibly allocate an independent output group to the multiple chargers based on the accessed information.

5. The system of claim 1, wherein the information associated with the multiple chargers disposed at the multiple stalls of the site includes information that identifies a load applied by an electric vehicle at one of the chargers of the multiple chargers disposed at the multiple stalls of the site.

6. The system of claim 1, wherein the information associated with the multiple chargers disposed at the multiple stalls of the site includes information that identifies a load applied by multiple electric vehicles charging at the multiple chargers.

7. The system of claim 1, wherein the information associated with the multiple chargers disposed at the multiple stalls of the site includes information that identifies a predicted load to be applied to the multiple chargers disposed at the multiple stalls of the site.

8. The system of claim 1, wherein each switch group includes two power blocks.

9. The system of claim 8, wherein each power block provides 25 kilowatts or 50 kilowatts of power to a charger disposed at the multiple stalls of the site.

10. The system of claim 1, wherein the processor is further configured to flexibly re-allocate one or more switch groups in response to completion of a charging event at the multiple chargers.

11. A power cabinet for an electric vehicle service equipment (EVSE), comprising:
multiple power blocks that provide a discrete amount of energy to a charger during a charging event with an electric vehicle (EV) connected to the charger; and
a charging system that dynamically allocates the multiple power blocks to two or more chargers associated with the power cabinet.

12. The power cabinet of claim 11, wherein the charging system is configured to:
group the power blocks into switch groups of multiple power blocks; and
allocate the switch groups to the two or more chargers associated with the power cabinet during multiple charging events powered by the EVSE.

13. The power cabinet of claim 11, wherein the charging system is configured to:
group the power blocks into switch groups of multiple power blocks; and
allocate each switch group to a charger of the two or more chargers.

14. The power cabinet of claim 11, wherein the charging system is configured to:
group a first subset of power blocks into switch groups of multiple power blocks;
group a second subset of power blocks into output groups of multiple power blocks,
wherein the switch groups are dynamically allocated to the two or more chargers and the output groups are assigned to the two or more chargers.

15. The power cabinet of claim 11, wherein the charging system is configured to:
group a third subset of power blocks into an independent output group of multiple power blocks.

16. The power cabinet of claim 11, wherein the charging system is configured to:
group a first subset of power blocks into a switch group associated with high power charging of EVs; and
group a second subset of power blocks into a switch group associated with lower power charging of EVs,
wherein the first subset of power blocks has a number of power blocks that is larger than a number of power blocks of the second subset of power blocks.

17. The power cabinet of claim 11, further comprising:
a contactor that couples the two or more chargers to the power cabinet.

18. A multi-mode architecture for a power cabinet of an electric vehicle service equipment (EVSE), comprising:
multiple output groups connected to chargers associated of the EVSE via contactors; and
multiple switch groups flexibly connected to the chargers of the EVSE via the contactors,
wherein an output group and a switch group both include multiple power blocks that provide a discrete amount of energy to a charger during a charging event with an electric vehicle (EV) connected to the charger.

19. The multi-mode architecture of claim 18, further comprising:
a charging system that dynamically allocates the multiple switch groups to the chargers of the EVSE.

20. The multi-mode architecture of claim 18, wherein a contactor associated with a switch group is smaller in size than a contactor associated with an output group.
